(19) United States
(12) Patent Application Publication
(10) Pub. No.: US 2025/0156973 A1
(43) Pub. Date: May 15, 2025

(54) SYSTEMS AND METHODS OF CONTRACT CLAUSE REVIEW FOR COMPLIANCE WITH ACQUISITION REGULATIONS

(71) Applicant: ABB Schweiz AG, Baden (CH)

(72) Inventor: Natalie Smittle, Fort Smith, AR (US)

(21) Appl. No.: 18/506,643

(22) Filed: Nov. 10, 2023

(51) Int. Cl. G06Q 50/18; G06N 20/00

(52) U.S. Cl. CPC G06Q 50/18; G06N 20/00

(57) ABSTRACT

A clause review system for reviewing contract clauses in an acquisition order is provided. The at least one processor of the system is programmed to execute machine learning models configured to detect clause identifiers in an acquisition order. The at least one processor is programmed to train the machine learning models using a first training dataset including first acquisition orders, and retrain the machine learning models using a second training dataset including second acquisition orders. At least one of the second acquisition orders has a different file format and/or a different sender entity from at least one of the first acquisition orders. The at least one processor is programmed to detect clause identifiers in an unprocessed acquisition order using the trained machine learning models, determine whether to accept contract clauses corresponding to the clause identifiers based on rules, and output a list of accepted contract clauses.

### BACKGROUND

The field of the disclosure relates generally to systems and methods of contract review, and more particularly, to systems and methods of contract clause review for compliance with acquisition regulations.

Acquisition regulations govern contracts with government agencies, with which the contracts should comply. When a recipient receives an acquisition order of government contracting, the acquisition order typically includes a relatively large number, e.g., several hundreds, of clause identifiers. Manual review of the contract clauses often takes weeks or more and poses risks from misidentifying and/or misinterpretation of the contract clauses due to human errors. Known systems and methods are disadvantaged in some aspects in meeting the needs in reviewing contract clauses in an acquisition order and improvements are desired.

### BRIEF DESCRIPTION

In one aspect, a clause review system for reviewing contract clauses in an acquisition order is provided. The clause review system includes at least one processor in communication with at least one memory device. The at least one processor is programmed to execute one or more machine learning models configured to detect clause identifiers in an acquisition order, wherein the clause identifiers identify corresponding acquisition regulations. The at least one processor is programmed to train the one or more machine learning models using a first training dataset including first acquisition orders. The at least one processor is also programmed to retrain the one or more machine learning models using a second training dataset including second acquisition orders. At least one of the second acquisition orders has a different file format and/or a different sender entity from at least one of the first acquisition orders. In addition, the at least one processor is programmed to detect clause identifiers in an unprocessed acquisition order using the one or more trained machine learning models, determine whether to accept contract clauses corresponding to the clause identifiers based on one or more rules, and output a list of accepted contract clauses in the unprocessed acquisition order.

In another aspect, one or more non-transitory machine-readable storage media for reviewing contract clauses in an acquisition order is provided. The one or more non-transitory machine-readable storage media include a plurality of instructions stored thereon that, in response to being executed, cause a system to execute one or more machine learning models configured to detect clause identifiers in an acquisition order. The clause identifiers identify corresponding acquisition regulations. The plurality of instructions further cause the system to train the one or more machine learning models using a first training dataset including first acquisition orders. The plurality of instructions also cause the system to retrain the one or more machine learning models using a second training dataset including second acquisition orders. The least one of the second acquisition orders has a different file format and/or a different sender entity from at least one of the first acquisition orders. The plurality of instructions further cause the system to detect clause identifiers in an unprocessed acquisition order using the one or more trained machine learning models, determine whether to accept contract clauses corresponding to the clause identifiers based on one or more rules, and output a list of accepted contract clauses in the unprocessed acquisition order.

In one more aspect, a clause review system for reviewing contract clauses in an acquisition order is provided. The clause review system includes at least one processor in communication with at least one memory device. The at least one processor is programmed to receive an acquisition order, and receive a list of factors of the acquisition order including a contract value of the acquisition order, a type of subject matter of the acquisition order, and/or a contractor tier of a recipient of the acquisition order. The at least one processor is also programmed to receive clause identifiers in the acquisition order. The at least one processor is further programmed to determine whether to accept contract clauses corresponding to the clause identifiers and/or whether the contract clauses apply to a subcontractor based on one or more rules and the list of factors by determining the one or more rules corresponding to the contract clauses based on prescriptions in the contract clauses. In addition, the at least one processor is programmed to output a list of accepted contract clauses, and output a list of flow down contract clauses in the acquisition order if the recipient of the acquisition order is subcontracting.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1A is a schematic diagram of a clause review system.

FIG. 1B illustrates an example program used to review contract clauses.

FIG. 2 is a flow chart of an example method of reviewing contract clauses.

FIG. 3 is a schematic diagram of an example computer system that may be used with the clause review system shown in FIG. 1A.

FIG. 4 is a block diagram of an example user computer device.

FIG. 5 is a block diagram of an example server computer device.

### DETAILED DESCRIPTION

The disclosure includes systems and methods of reviewing contract clauses in an acquisition order for compliance with acquisition regulations. As used herein, an acquisition order refers to an order, an award, a grant for a government contract. An acquisition order may be an award under appropriated funding, which is also called procurement, or through a grant, issued by a government agency, or an order provided by a contractor having a government contract with a government agency. Contract clauses in federal acquisition regulations (FAR) are described as example for illustration purposes only. Systems and methods described herein may be applied to regulations promogulated by any government agencies that govern contract clauses in a contract. Method aspects will be in part apparent and in part explicitly discussed in the following description.

Acquisition regulations govern government contracting and include requirements that a contracting party to a government contract need to meet. The requirements are codified in the Code of Federal Regulations (C.F.R.), such as 48 C.F.R. part 52. The total number of contract clauses stipulated in the regulations is in the level of thousands. The regulations are in the form of contract clauses to be inserted into the contract. When a government contract is built to be compliant with the federal requirements, the acquisition order references the regulations such as the FAR. The references are clause identifiers, which identifies regulations with which the recipient of the acquisition order may need to comply. For example, when the government awards a contract, the award includes a list of clause identifiers.

In a given acquisition order, hundreds or more of clause identifiers are included. A recipient often does not review the contract clauses and instead accepts the contract as they are, foregoing the opportunity to negotiate the terms of the contract and to mitigate risks to the recipient. Some recipients manually review an acquisition order, by manually examining all the clause identifiers in the acquisition order and the corresponding contract clauses. The process may take weeks or more due to the sheer number of clause identifiers in an acquisition order.

In contrast, systems and methods described herein enable the processing of an acquisition order by applying rules to the clause identifiers. Systems and methods described herein detect clause identifiers using machine learning models. The systems and methods described herein are independent of the formats of the acquisition orders or the sender entities of the acquisition orders. The time needed to review and negotiate an acquisition order is reduced to the order of hours or less.

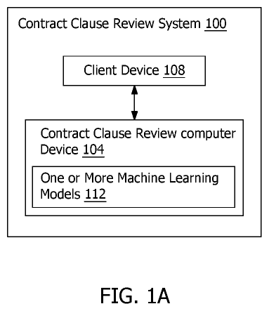

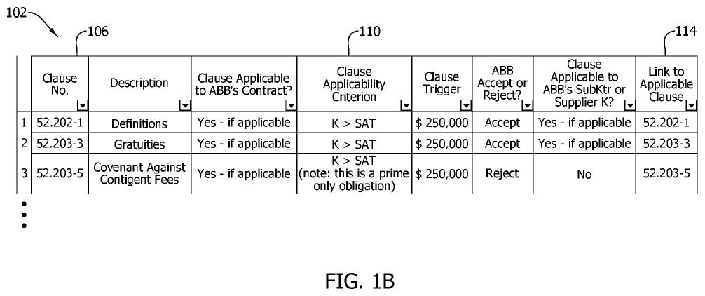

FIGS. 1A and 1B illustrate an example clause review system 100 that may be used to process an acquisition order. FIG. 1A is a schematic diagram of the clause review system 100. FIG. 1B shows an example program 102 implemented with a clause review computer device 104 of the clause review system 100. FIG. 1A illustrates one clause review system 100 in accordance with at least one embodiment. In the example embodiment, in clause review system 100, an acquisition order is being reviewed and processed. An acquisition order may be a government award, a purchase order, or a request for proposal (RFP). Besides details of the contract such as the subject matter and types of contract like in a typical order, an acquisition order includes clause identifiers 106 (see FIG. 1B), which correspond to the requirements that the recipients may need to comply. An acquisition order may have several hundred pages and may include several hundreds of clause identifiers.

As shown in FIG. 1A, in the example embodiment, the clause review system 100 includes a client device 108. The client device 108 includes a user interface configured to receive inputs from a user. The client device 108 may be implemented on the clause review computer device 104. Alternatively, the client device may be provided on an application such as a mobile app or a web application that is accessible to the user.

In the example embodiment, the client device 108 is configured to receive an acquisition order and an information sheet. The information sheet includes a list of factors as inputs used in applying the rules to process contract clauses. The list of factors may be input in other formats that enable the client device 108 functions as described herein. For example, the list of factors may be answers or choices to questions provided by the client device 108. The list of factors may include the contract value, a type of contract, and/or the contract tier of the recipient. The list of factors may also include whether the recipient is subtracting. The inputs may include other information that enable the clause review system 100 to function as described herein.

In the example embodiment, the clause review system 100 includes the clause review computer device 104 configured to process an acquisition order. The clause review computer device 104 determines whether to accept contract clauses in the acquisition order and/or whether contract clauses apply to a subcontractor. The determination is based on one or more rules specific to each of the contract clauses. Each rule may take a factor as an input.

In the example embodiment, the list of factors are input into the clause review computer device 104 and used in processing the acquisition order by applying rules to the factors. For example, if the acquisition order includes clause 52.203-11 and the factor of the contract value is $140,000, the clause review computer device 104 determines that the contract clause is not applicable and rejects the clause, by applying the rule that if the contract value exceeds the threshold value of $150,000, the contract clause is accepted, and if otherwise, the contract clause is rejected. In another example, if the acquisition order includes 52.204-21, and the factors indicate the recipient is a subcontractor, the clause review computer device 104 determines that the clause applies to a subcontractor, by applying the rules that the clause applies a recipient regardless of the contract tier of the recipient.

In the example embodiment, the clause review computer device 104 reviews all of the clauses referenced by the clause numbers, and determine whether the clause applies to the contract. A clause may be mandatory or conditional. For example, clause identifier 52.203-11 is identified in the acquisition order. Regulation 52.203-11 is reviewed. A FAR clause typically includes a prescription, which governs the applicability of the clause. To determine whether the clause should be included in the contract, the prescription is reviewed. For example, 52.203-11 includes a prescription in FAR Part 3.808(a). The prescription states, “Insert the provision at 52.203-11, Certification and Disclosure Regarding Payments to Influence Certain Federal Transactions, in solicitations expected to exceed $150,000.” 48 C.F.R. 3.808(a). If the contract value of the acquisition order is equal to or less than $150,000, clause 52.203-11 is optional and may be rejected. A contract value is the anticipated award value of the contract. If the contract value of the acquisition order is more than $150,000, contract clause 52.203-11 is mandatory and is required to be inserted in the contract.

In the example embodiment, the type of subject matter of the contract may be a factor in determining whether a contract clause is applicable. For example, prescription 4.1705(a) of 52.204-14 states, “The contracting officer shall insert the clause at 52.204-14, Service Contract Reporting Requirements, in solicitations and contracts for services (including construction) that meet or exceed the thresholds at 4.1703, except for indefinite-delivery contracts . . . .” If the type of subject matter of the contract is services, clause 52.024-14 is mandatory if the contract meets a threshold in FAR Part 4.1703, which is the SAT (simplified acquisition threshold). If the type of subject matter of the contract is product, clause 52.024-14 does not apply and may be rejected by the recipient.

In the example embodiment, a recipient may be at various tiers in the contract chain. For example, the recipient may be a prime, which receives the acquisition order directly from the government and is a contracting party with the government. The recipient may be a subcontractor of the prime, a subcontractor of a contractor in a higher tier, or a supplier. As used herein, a subcontractor refers generally to a subcontractor of any tier or a supplier. The clause review computer device 104 is configured to determine whether a contract clause should apply or flow down to the subcontractor based on a contract tier of the recipient. A flow down clause is a clause that applies to a subcontractor besides the prime. If the contract clause includes an obligation for the subcontractor, the contract clause is a mandatory flow down, where the contract clause applies to a subcontractor and the recipient as a subcontractor may not reject the contract clause. A mandatory flow down clause is required to be inserted into the contract. If the contract clause is silent as to the obligation for a subcontractor, the contract clause is optional for a subcontractor and a recipient as a subcontractor may reject the contract clause. The word “subcontractor” may be used as a keyword in determining whether a contract clause is a mandatory flow down clause. For example, the prescription of FAR Part 4.1903 of 52.204-21 states, “The contracting officer shall insert the clause at 52.204-21, Basic Safeguarding of Covered Contractor Information Systems, in solicitations and contracts when the contractor or a subcontractor at any tier may have Federal contract information residing in or transiting through its information system.” As such, clause 52.204-21 is a mandatory flow down clause to subcontractors that have any federal contract information either residing in or transiting through the information system.

In the example embodiment, the clause review computer device 104 is configured to display the rules 110 that are applied in reviewing and processing a contract clause (see FIG. 1B).

In some embodiments, the clause review computer device 104 is configured to determine the rules 110. The rules may be generated based on prescriptions of the contract clauses. For example, the clause review computer device 104 may generate a rule that a contract clause is mandatory if the condition stated in the prescription of the contract clause has been met. The condition may be based on factors such as the contract value and/or types of subject matter. The clause review computer device 104 is further configured to generate a rule for determining whether a contract clause is a mandatory flow down clause. For example, the rule may be that if the prescription of a contract clause includes obligations for a subcontractor, the contract clause is a mandatory flow down, and if the prescription does not include obligations for a subcontractor, the flow down clause of the contract clause is not mandatory.

In the example embodiment, the clause review computer device 104 includes one or more models 112 generated by machine learning (ML). In at least one embodiment, the one or models include a neural network. The clause review computer device 104 trains the one or more models using historical order dataset where the results of the contract clauses in the acquisition order are known. In at least one embodiment, at least one model is trained for each individual sender entity, where different entities may have different attributes, such as different list of clause identifiers and/or different government agencies. A sender entity is the entity that sends an acquisition order, which may be a government agency, a contractor, or a subcontractor.

In one embodiment, the clause review computer device 104 trains the one or more models to detect and classify clause identifiers. The clause review computer device 104 processes the acquisition orders. The clause review computer device 104 executes one or more ML models with the historical order dataset as inputs. The models output clause identifiers based on the inputs. The models are trained to recognize the patterns of clause identifiers. For example, the models 112 recognize that clause identifiers are a string of numbers separate by a period and a dash. Specifically, the string of numbers starting with 52 indicates a FAR contract clause. A string of numbers starting with 252 indicates a DFARS (Defense Federal Acquisition Regulation Supplement) contract clause.

In one example, the clause review computer device 104 trains a model for a first entity based upon historical order datasets from that first entity. In a further embodiment, a base model is trained from historical order datasets in a plurality of file formats. For example, the formats of the acquisition orders may be in Word®, portable document format (pdf), or an image of the acquisition order. Then the base model is retrained with acquisition order datasets from the first entity that the clause review computer device 104 will be processing. The base model can also be trained with the acquisition order datasets from other entities, acquisition orders of which that the clause review computer device 104 will be processing. As a result, the models 112 are configured to extract clause identifiers in an acquisition order, independent of the formats of the acquisition orders and/or the sender entities issuing the acquisition orders, thereby increasing the accuracy and reliability of the detection by the models 112.

In some embodiments, the one or more models 112 are configured to determine rules 110 in processing contract clauses. The one or more models 112 may be trained with contract clauses with the associated rules known. The one or more models 112 may be re-trained with contract clauses, which the one or more models 112 will be processing. The re-training fine-tunes the one or more models 112.

In some embodiments, the clause review system 100 includes a plurality of clause review computer devices 104. One of clause review computer device 104 trains the one or more models 112. The use of the one or more models 112 is executed on another clause review computer device 104.

In the example embodiment, the clause review computer device 104 processes the acquisition orders and output contract clauses that are to be accepted. If the recipient is subcontracting, a list of flow down clauses is output by the clause review computer device 104. If the recipient is not subcontracting the contract further to a lower tier subcontractor, the list of flow down clauses may not be output.

In the example embodiment, the clause review computer device 104 is in communication with one or more client devices 108. The clause review computer device 104 may generate reports about contract clauses and provide those reports to the one or more client devices 108.

In the example embodiment, the clause review computer device 104 is further configured to link with websites that maintain the regulations to facilitate manual review of the contract clauses. For example, the FAR clauses are maintained by www.acquistion.gov. The clause review computer device 104 provides links 114 (see FIG. 1B) to the FAR. Manual review facilitates the verification of the review by the clause review computer device 104. The verified results may be stored or added into historical order datasets as training datasets for training the one or more machine learning models 112. In some embodiments, the clause review computer device 104 is configured to notify changes to the regulations or update the rules 110. For example, the clause review computer device 104 detects that the regulations have been changed by detecting a notification on the website. The clause review computer device 104 may notify the changes by sending a message to a user via the client device 108. The clause review computer device 104 may update the rules 110 after the detection of changes.

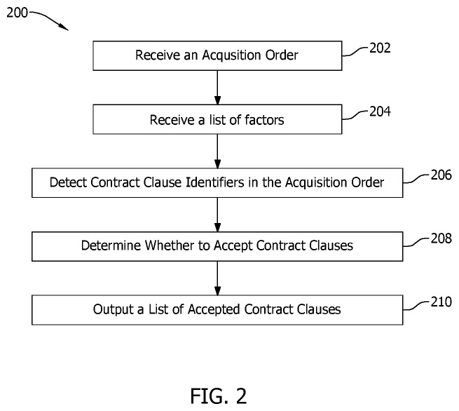

FIG. 2 is a flow chart of an example method 200 of reviewing contract clauses. In the example embodiment, the method 200 includes receiving 202 an acquisition order. The method 200 also includes receiving 204 a list of factors. The list of factors may be provided in an information sheet or inputs from a user in other formats. The list of factors may include a contract value, a type of subject matter, a contractor tier of the acquisition order, and/or whether the recipient is subcontracting. The method 200 further includes detecting 206 clause identifiers in the acquisition order. The clause identifiers may be detected by one or more machine learning models. In some embodiments, the clause identifiers are detected by manual examination of the acquisition order.

In the example embodiments, the method 200 includes determining 208 whether to accept contract clauses corresponding to the clause identifiers based on one or more rules and the list of factors. Whether contract clauses apply to a subcontractor may be determined. If the recipient is a subcontractor and the contract clause does not apply to a subcontractor, the recipient may reject the clause. The method also includes outputting 210 a list of accepted contract clauses. A list of flow down clauses is also output when the recipient of the acquisition order is subcontracting.

The systems and methods described herein increase the speed in review contract clauses and mitigate risks for the recipient. The systems and methods described herein are advantageous also in reducing errors from manual review, thereby increasing the consistency, accuracy, transparency, and efficiency in reviewing and negotiating acquisition contract clauses. The system provides a list of the rules applied in reviewing and negotiating the contract, thereby providing support in contract negotiation and evidence showing compliance.

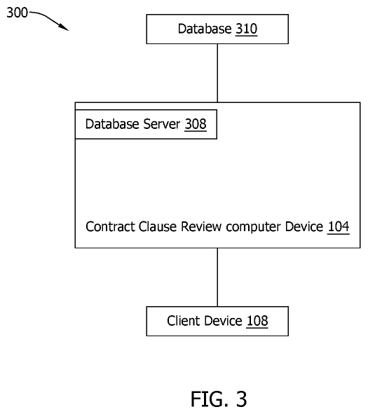

FIG. 3 illustrates an example computer system 300 that may be used with the clause review system 100 (shown in FIG. 1A). In the example embodiment, the computer system 300 receives an acquisition order. The computer system 300 may be configured to detect clause identifiers 106 in the acquisition order. In some embodiments, the computer system 300 receives clause identifiers 106 in the acquisition order from the client device 108. Based on the list of factors received from the client device 108, the computer system 300 is configured to apply one or more rules and determine whether to accept the contract clauses corresponding to the clause identifiers 106. The computer system 300 is also configured to determine whether the contract clauses should flow down to downstream subcontractors. Further, the computer system 300 is configured to output the list of accepted contract clauses and/or the list of flow down contract clauses.

As described herein in more detail, the clause review computer device 104 is programmed to analyze the acquisition order received from the client device 108 (shown in FIG. TA) to detect and/or classify clause identifiers in an acquisition order. In addition, the clause review computer device 104 is programmed to continuously update and “train” one or more models used to detect, classify, and report contract clauses. The clause review computer device 104 is programmed to a) store one or more models trained to detect clause identifiers; b) receive an acquisition order; c) execute the one or more models with the acquisition order to detect clause identifiers in the acquisition order; and d) determine whether to accept the contract clauses and/or include the contract clauses in a list of flow down clauses. In some embodiments, the clause review computer device 104 is programmed to determine rules based on the contract clauses. The clause review computer device 104 is programmed to continuously update and “train” one or more models used to determine the rules. The clause review computer device 104 is further programmed to a) store one or more models trained to determine rules; b) receive a clause identifier; and c) execute the one or more models with the clause identifier to determine the rules.

In the example embodiment, the client device 108 can be any computer device capable of receiving input from a user (shown in FIG. TA). The input may include one or more acquisition orders and/or an information sheet. The information sheet includes a list of factors used to determine whether to accept a contract clause and/or whether to include a contract clause in a list of flow down clauses. Client device 108 connects to the clause review computer device 104 through many interfaces including without limitation a network, such as a local area network (LAN) or a wide area network (WAN), dial-in-connections, cable modems, Internet connection, wireless, and special high-speed Integrated Services Digital Network (ISDN) lines. The client device 108 receives data about the acquisition order and report the data to the clause review computer device 104.

In the example embodiment, client devices 108 are computers that include a web browser or a software application, which enables client devices 108 to communicate with clause review computer device 104 using the Internet, a local area network (LAN), or a wide area network (WAN). In some embodiments, the client devices 108 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 108 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots or ChatGPT-based bots, or other web-based connectable equipment or mobile devices.

In the example embodiment, clause review computer device 104 is a computer that includes a web browser or a software application, which enables clause review computer device 104 to communicate with client devices 108 using the Internet, a local area network (LAN), and/or a wide area network (WAN). In some embodiments, the clause review computer device 104 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. clause review computer device 104 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots or ChatGPT-based bots, or other web-based connectable equipment or mobile devices.

A database server 308 is communicatively coupled to a database 310 that stores data. In one embodiment, the database 310 is a database that includes one or more detection, classification, and/or identification models, thresholds, and/or other information. In some embodiments, the database 310 is stored remotely from the clause review computer device 104. In some embodiments, the database 310 is decentralized. In the example embodiment, a person can access the database 310 via the client devices 108 by logging onto clause review computer device 104.

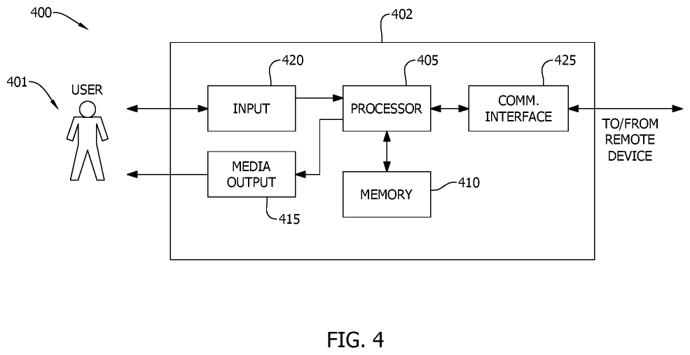

FIG. 4 depicts an example configuration 400 of user computer device 402, in accordance with one embodiment of the present disclosure. In the example embodiment, user computer device 402 may be similar to, or the same as, client device 108 and clause review computer device 104 (both shown in FIGS. 1A and 3). User computer device 402 may be operated by a user 401.

User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an interface for viewing information provided by the computer system 300 (shown in FIG. 1A). In some embodiments, user computer device 402 may include an input device 420 for receiving input from user 401. User 401 may use the input device 420 to, without limitation, provide information either through speech or typing.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as client device 108 or clause review computer device 104. Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from clause review computer device 104. A client application may enable user 401 to interact with, for example, clause review computer device 104. For example, instructions may be stored by a cloud service, and the output of the execution of the instructions sent to the media output component 415.

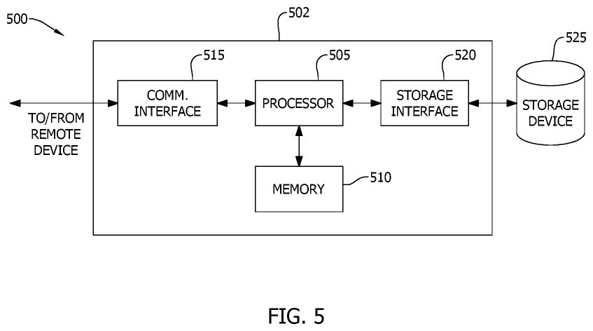

FIG. 5 depicts an example configuration 500 of a server computer device 502, in accordance with one embodiment of the present disclosure. In the example embodiment, server computer device 502 may be similar to, or the same as, clause review computer device 104, computer system 300 (both shown in FIG. 1A), and database server 308 (shown in FIG. 3). Server computer device 502 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 502 is capable of communicating with a remote device such as another server computer device 502, clause review computer device 104, clause review system 100, computer system 300, and client devices 108 (shown in FIGS. 1A and 3) (for example, using wireless communication or data transmission over one or more radio links or digital communication channels). For example, communication interface 515 may receive information from the client device (shown in FIG. 1A) via the Internet, as illustrated in FIG. 1A.

Processor 505 may also be operatively coupled to a storage device 525. Storage device 525 may be any computer-operated hardware suitable for storing and/or retrieving data, such as, but not limited to, data associated with one or more models. In some embodiments, storage device 525 may be integrated in server computer device 502. For example, server computer device 502 may include one or more hard disk drives as storage device 525.

In other embodiments, storage device 525 may be external to server computer device 502 and may be accessed by a plurality of server computer devices 502. For example, storage device 525 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 525 via a storage interface 520. Storage interface 520 may be any component capable of providing the processor 505 with access to storage device 525. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 505 with access to storage device 525.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated herein.

### Machine Learning and Other Matters

The computer-implemented methods discussed herein may include additional, or alternative actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, clause review computer device 104 is programmed to implement machine learning, such that clause review computer device 104 “learns” to analyze, organize, and/or process data without being explicitly programmed to do so. Machine learning may be implemented through machine learning methods and algorithms (“ML methods and algorithms”). In an example embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, material detection, material classification, material quantification, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the example embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

Based upon these analyses, the processing element may learn how to identify characteristics and patterns that may then be applied to analyzing images of components for and identifying deviations from baseline. The processing element may also learn how to identify attributes of different objects in different lighting and/or other conditions. This information may be used to determine which classification models to use and which classifications to provide.

### Additional Considerations

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

At least one technical effect of the systems and methods described herein includes (a) systems and methods of processing an acquisition order to determine whether to accept contract clauses in the acquisition order; (b) systems and methods of processing an acquisition order to determine whether contract clauses apply to a subcontractor; (c) detecting clause identifiers using one or more machine learning model; and (d) determining one or more rules in processing contract clauses using one or more machine learning models.

Example embodiments of systems and methods of reviewing contract clauses are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A clause review system for reviewing contract clauses in an acquisition order, the clause review system comprising at least one processor in communication with at least one memory device, wherein the at least one processor is programmed to:
execute one or more machine learning models configured to detect clause identifiers in an acquisition order, wherein the clause identifiers identify corresponding acquisition regulations;
train the one or more machine learning models using a first training dataset including first acquisition orders;
retrain the one or more machine learning models using a second training dataset including second acquisition orders, wherein at least one of the second acquisition orders has a different file format and/or a different sender entity from at least one of the first acquisition orders;
detect clause identifiers in an unprocessed acquisition order using the one or more trained machine learning models;
determine whether to accept contract clauses corresponding to the clause identifiers based on one or more rules; and
output a list of accepted contract clauses in the unprocessed acquisition order.

2. The clause review system of claim 1, wherein the at least one processor is further programmed to:
determine the one or more rules corresponding to the contract clauses based on prescriptions in the contract clauses.

3. The clause review system of claim 1, wherein the at least one processor is further programmed to:
determine whether the contract clauses corresponding to the clause identifiers apply to a subcontractor; and
output a list of flow down contract clauses if a recipient of the acquisition order is subcontracting.

4. The clause review system of claim 1, wherein the at least one processor is further programmed to:
receive a list of factors of the acquisition order; and
determine whether to accept the contract clauses and/or whether the contract clauses apply to a subcontractor based on the list of factors and the one or more rules.

5. The clause review system of claim 4, wherein the at least one processor is further programmed to:
receive the list of factors including a contract value of the acquisition order; and
determine whether to accept the contract clauses based on the contract value and the one or more rules.

6. The clause review system of claim 4, wherein the at least one processor is further programmed to:
receive the list of factors including a type of subject matter of the acquisition order; and
determine whether to accept the contract clauses based on the type of subject matter and the one or more rules.

7. The clause review system of claim 4, wherein the at least one processor is further programmed to:
receive the list of factors including a contractor tier of a recipient of the acquisition order; and
determine whether the contract clauses apply to a subcontractor based on the contractor tier and the one or more rules.

8. The clause review system of claim 1, wherein the at least one processor is further programmed to:
determine whether to accept the contract clauses by:
communicating with a website that maintains acquisition regulations.

9. The clause review system of claim 1, wherein the one or more machine learning models are configured to determine the one or more rules based on the contract clauses.

10. The clause review system of claim 1, comprising a client device configured to communicate with a user, wherein the client device is provided on an application.

11. One or more non-transitory machine-readable storage media for reviewing contract clauses in an acquisition order, comprising a plurality of instructions stored thereon that, in response to being executed, cause a system to:
execute one or more machine learning models configured to detect clause identifiers in an acquisition order, wherein the clause identifiers identify corresponding acquisition regulations;
train the one or more machine learning models using a first training dataset including first acquisition orders;
retrain the one or more machine learning models using a second training dataset including second acquisition orders, wherein at least one of the second acquisition orders has a different file format and/or a different sender entity from at least one of the first acquisition orders;
detect clause identifiers in an unprocessed acquisition order using the one or more trained machine learning models;
determine whether to accept contract clauses corresponding to the clause identifiers based on one or more rules; and
output a list of accepted contract clauses in the unprocessed acquisition order.

12. The one or more non-transitory machine-readable storage media of claim 11, wherein the plurality of instructions further cause the system to:
determine the one or more rules corresponding to the contract clauses based on prescriptions in the contract clauses.

13. The one or more non-transitory machine-readable storage media of claim 11, wherein the plurality of instructions further cause the system to:
determine whether the contract clauses corresponding to the clause identifiers apply to a subcontractor; and
output a list of flow down contract clauses if a recipient of the acquisition order is subcontracting.

14. The one or more non-transitory machine-readable storage media of claim 11, wherein the plurality of instructions further cause the system to:
receive a list of factors of the acquisition order; and
determine whether to accept the contract clauses and/or whether the contract clauses apply to a subcontractor based on the list of factors and the one or more rules.

15. The one or more non-transitory machine-readable storage media of claim 14, wherein the plurality of instructions further cause the system to:
receive the list of factors including a contract value of the acquisition order; and
determine whether to accept the contract clauses based on the contract value and the one or more rules.

16. The one or more non-transitory machine-readable storage media of claim 14, wherein the plurality of instructions further cause the system to:
receive the list of factors including a type of subject matter of the acquisition order; and
determine whether to accept the contract clauses based on the type of subject matter and the one or more rules.

17. The one or more non-transitory machine-readable storage media of claim 14, wherein the plurality of instructions further cause the system to:
receive the list of factors including a contractor tier of a recipient of the acquisition order; and
determine whether the contract clauses apply to a subcontractor based on the contractor tier and the one or more rules.

18. The one or more non-transitory machine-readable storage media of claim 11, wherein the plurality of instructions further cause the system to:
determine whether to accept the contract clauses by:
communicating with a website that maintains the acquisition regulations.

19. The one or more non-transitory machine-readable storage media of claim 11, wherein the one or more machine learning models are configured to determine the one or more rules based on the contract clauses.

20. A clause review system for reviewing contract clauses in an acquisition order, the clause review system comprising at least one processor in communication with at least one memory device, wherein the at least one processor is programmed to:
receive an acquisition order;
receive a list of factors of the acquisition order including a contract value of the acquisition order, a type of subject matter of the acquisition order, and/or a contractor tier of a recipient of the acquisition order;
receive clause identifiers in the acquisition order;
determine whether to accept contract clauses corresponding to the clause identifiers and/or whether the contract clauses apply to a subcontractor based on one or more rules and the list of factors by:
determining the one or more rules corresponding to the contract clauses based on prescriptions in the contract clauses;
output a list of accepted contract clauses; and
output a list of flow down contract clauses in the acquisition order if the recipient of the acquisition order is subcontracting.
